(19) United States
(12) Patent Application Publication
(10) Pub. No.: US 2015/0006236 A1
(43) Pub. Date: Jan. 1, 2015

(54) RULES VISUALIZATION USING AN EXPRESSION TREE

(71) Applicant: International Business Machines Corporation, Armonk, NY (US)

(72) Inventors: Amol B. Deshpande, Pune (IN); Saurabh Dwivedi, Pune (IN); Nidhi S. Kulkarni, Pune (IN)

(21) Appl. No.: 14/490,759

(22) Filed: Sep. 19, 2014

Related U.S. Application Data
(63) Continuation of application No. 13/911,258, filed on Jun. 6, 2013.

(51) Int. Cl. G06Q 10/06

(52) U.S. Cl. CPC G06Q 10/06316
USPC 705/7.26

(57) ABSTRACT

Representing a business rule by: (i) determining an expression tree corresponding to the business rule; and (ii) displaying the expression tree. The business rule is a business rule used in one or more OLAP cubes and can be debugged and/or edited through an OLAP utility.

### FIELD OF THE INVENTION

The present invention relates generally to the field of online analytical processing (OLAP), and more particularly to visualization of rules applicable to OLAP cubes.

### BACKGROUND OF THE INVENTION

Expression trees are known. An expression tree represents a mathematical expression as a hierarchy of nodes. Two common types of expressions that an expression tree can represent are: (i) algebraic; and (ii) Boolean. An expression tree can represent an expression that includes both unary and binary operators. A binary expression tree is an expression tree in which all nodes have zero, one or two child nodes. The leaves of an expression tree are operands, such as constants or variable names, and the other nodes contain operators. An algebraic expression can be generated based upon an expression tree by: (i) recursively producing a parenthesized left expression; (ii) printing out the operator at the root; and (iii) recursively producing a parenthesized right expression. This general strategy (left, node, right) is called in-order traversal.

Online analytical processing (OLAP) is a computing technique for summarizing, consolidating, viewing, applying formulae to, and synthesizing data according to multiple dimensions. OLAP software enables users, such as analysts, managers and executives, to gain insight into performance of an enterprise through rapid access to a wide variety of data views that are organized to reflect the multidimensional nature of the enterprise performance data. An increasingly popular data model for OLAP is a multidimensional database (MDDB), which is also known as the data cube.

An OLAP cube is an array of data understood in terms of its dimensions (which may vary in number on a cube by cube basis). OLAP is a computer-based technique that is often used to analyze business data in order to generate business intelligence. An OLAP cube can be considered a generalization of a three-dimensional spreadsheet. For example, a company might wish to summarize financial data by product, by time-period, by city to compare actual and budget expenses. Product, time, city and scenario (actual and budget) are the data's dimensions. The term “OLAP hypercube” is sometimes used, especially for data with more than three dimensions. Each cell of an OLAP cube holds a number that represents some measure of the business, such as sales, profits, expenses, budget and forecast. OLAP data is typically stored in a star schema (or snowflake schema) in: (i) a relational data warehouse; and/or (ii) a special-purpose data management system.

The elements of a dimension can be organized as a hierarchy, a set of parent-child relationships, typically where a parent member summarizes its children. Parent elements can further be aggregated as the children of another parent.

In an OLAP system, business rules are usually a prominent part of daily analysis and budgeting. Developers are frequently tasked with debugging these business rules. This debugging prevents incorrect rules from leading to incorrect calculations that negatively impact business decisions.

### SUMMARY

According to an aspect of the present invention, there is a method for representing a business rule. The method includes the following steps (not necessarily in the following order): (i) determining an expression tree corresponding to the business rule; and (ii) displaying the expression tree. At least the determining and displaying steps are performed by computer software running on computer hardware.

### BRIEF DESCRIPTION OF THE SEVERAL VIEWS OF THE DRAWINGS

FIG. 1 is a schematic view of a first embodiment of a computer system (that is, a system including one or more processing devices) according to the present invention;

FIG. 2 is a schematic view of a computer sub-system (that is, a part of the computer system that itself includes a processing device) portion of the first embodiment computer system;

FIG. 3 is a flowchart showing a process performed, at least in part, by the first embodiment computer system;

FIG. 4 is a schematic view of a portion of the first embodiment computer system;

FIG. 5 is a first screenshot generated by the first embodiment computer system; and

FIG. 6 is a second screenshot showing an expression tree according to the present invention.

### DETAILED DESCRIPTION

This DETAILED DESCRIPTION section will be divided into the following sub-sections: (i) The Hardware and Software Environment; (ii) Operation of Embodiment(s) of the Present Invention; (iii) Further Comments and/or Embodiments; and (iv) Definitions.

### I. The Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

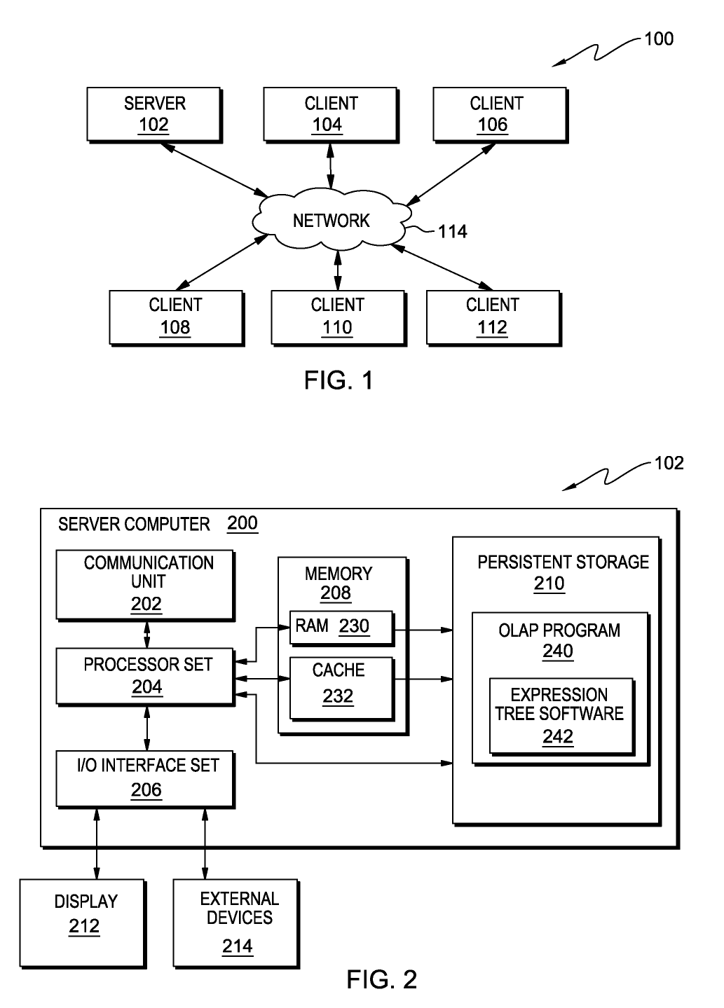

An embodiment of a possible hardware and software environment for software and/or methods according to the present invention will now be described in detail with reference to the Figures. FIGS. 1 and 2 collectively make up a functional block diagram illustrating various portions of distributed data processing system 100, including: server computer sub-system (that is, a portion of the larger computer system that itself includes a computer) 102; client computer sub-systems 104, 106, 108, 110, 112; communication network 114; server computer 200; communication unit 202; processor set 204; input/output (i/o) unit 206; memory device 208; persistent storage device 210; display device 212; external device set 214; random access memory (RAM) devices 230; cache memory device 232; OLAP program 240; and expression tree software 242.

As shown in FIG. 2, server computer sub-system 102 is, in many respects, representative of the various computer sub-system(s) in the present invention. Accordingly, several portions of computer sub-system 102 will now be discussed in the following paragraphs.

Server computer sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 240 is a representative piece of software, and is a collection of machine readable instructions and data that is used to create, manage and control certain software functions that will be discussed in detail, below, in the Operation of the Embodiment(s) sub-section of this DETAILED DESCRIPTION section. Program 240 may be run locally at the server computer itself, or run remotely, at the request and control of the various client computer sub-systems.

Server computer sub-system 102 is capable of communicating with other computer sub-systems via network 114 (see FIG. 1). Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

It should be appreciated that FIGS. 1 and 2, taken together, provide only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications and the like.

As shown in FIG. 2, server computer sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 240 is in many respects representative of the various software modules of the present invention and is stored in persistent storage 210 for access and/or execution by one or more of the respective computer processors 204, usually through one or more memories of memory 208. Persistent storage 210 is at least more persistent than a signal in transit is, but the persistent storage may, of course, be substantially less persistent than permanent storage. Program 240 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102, such as client sub-systems 104, 106, 108, 110, 112. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface(s) 206 allows for input and output of data with other devices that may be connected locally in data communication with server computer 200. For example, I/O interface 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. Operation of Embodiment(s) of the Present Invention

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

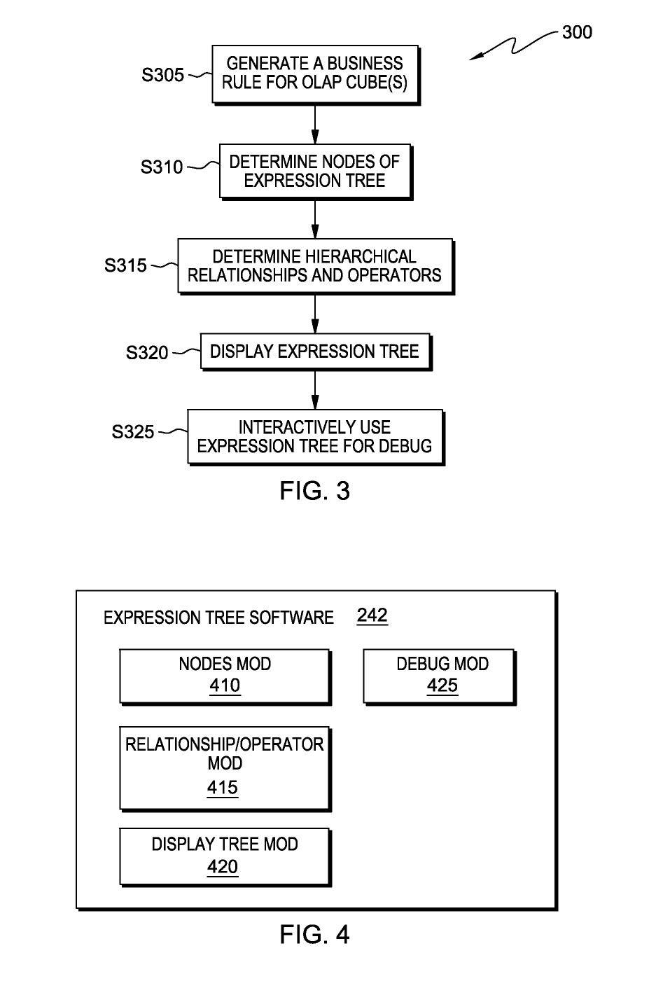

FIG. 3 shows a flow chart 300 depicting a method according to the present invention. FIG. 4 shows expression tree software 242 for performing at least some of the method steps of flow chart 300. This method and associated software will now be discussed, over the course of the following paragraphs, with extensive reference to FIG. 3 (for the method step blocks) and FIG. 4 (for the software blocks).

Processing starts at step S305 where a user using OLAP program 240 (see FIG. 1) generates a business rule for use with one or more OLAP cubes implemented through the OLAP program. In this example, the business rule may be expressed (more or less comprehensively) by each of the following equations:

Variable definition: (i) PPCY=projected profit for current year; (ii) PJ=profit for January; (iii) IJ=income for January; (iv) CJ=costs for January; (v) SIJ=sales income for January; (vi) IIJ=investment income for January; (vii) OPEXJ=operating expenses for January; (viii) CAPEXJ=capital expenses for January; (ix) ILJ=investment losses for January; (x) SALJ=salaries for January; (xi) RENTJ=rent for January; and (xii) UJ=utilities for January.

PPCY=12*PJ Equation 1:

PPCY=12*{IJ−CJ} Equation 2:

PPCY=12*{(SIJ+IIJ)−(OPEXJ+CAPEXJ+ILJ)} Equation 3:

PPCY=12*{(SIJ+IIJ)−((SALJ+RENTJ+UJ)+CAPEXJ+ILJ)} Equation 4:

Processing proceeds to step S310 where nodes module (mod) 410 determines nodes for the expression tree. In this example, the nodes will be the various terms of equation 4, specifically: PPCY, 12, SIJ, IIJ, SALJ, RENTJ, UJ, CAPEXJ, and ILJ.

Processing proceeds to step S315 where relationship/operator mod 415 determines the relationships and associated operators for the expression tree. In some embodiments, mod 415 will also determine sample numerical values for the nodes, although the present example does not include such sample numerical values.

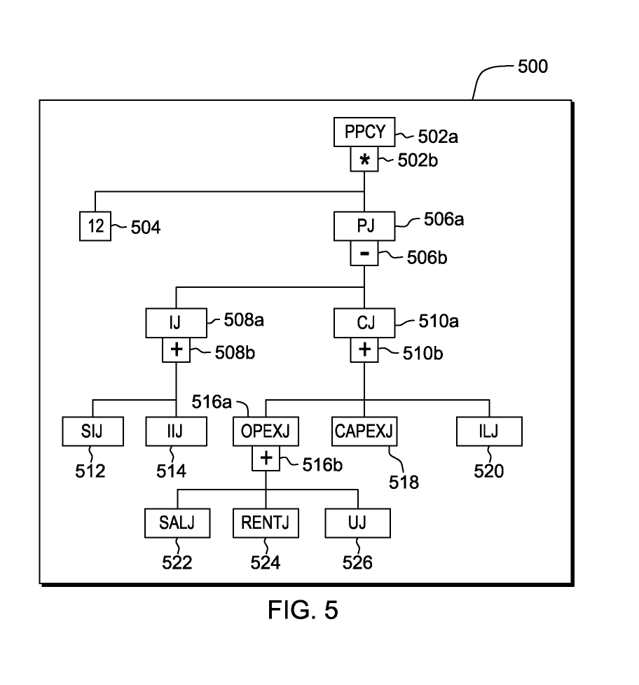

Processing proceeds to step S320 where display tree mod 420 displays the expression tree. This is shown by display 500 of FIG. 5. The expression tree of display 500 includes: first node 502 (including term 502a and operator 502b); second node 504; third node 506 (including term 506a and operator 506b); fourth node 508 (including term 508a and operator 508b); fifth node 510 (including term 510a and operator 510b); sixth node 512; seventh node 514; eighth node 516 (including term 516a and operator 516b); ninth node 518; tenth node 520; eleventh node 522; twelfth node 524; and thirteenth node 526. It is noted that the various terms and operators correspond to Equation 4, set forth above.

Processing proceeds to step S325 where debug mod 425 is used to control and manage debugging of the business rule of the expression tree by a user. The expression tree makes it easier for the user to debug the business rule so that the corrected rule is used in OLAP program 240 (see FIG. 1).

### III. Further Comments and/or Embodiments

Some embodiments of the present invention represent OLAP business rules in a more diagrammatic way to: (i) debug the business rules; and (ii) trace the dependency between OLAP cubes. Some embodiments utilize expression trees to visualize the rules in a more detailed and elaborate manner, thus making the business rules very easy to understand and/or debug. In an organization, business rules and calculations used in financial analysis are complex and have to be changed regularly according to changes in business processes. Several factors (for example, government norms and policies) are responsible for these changes. The business rules in an OLAP tool also have to be changed accordingly. Keeping track of the changes in formulas and maintaining the accuracy of the rules often becomes crucial for financial analysis. Currently in conventional OLAP tools the methods to debug business rules can be difficult for users (see Definitions sub-section, below, of this DETAILED DESCRIPTION section).

Some embodiments of the present invention enable the user to debug rules in a better and more understandable manner which can potentially save time and/or mental effort. Some embodiments of the present invention: (i) combine the power of visualization with business rules in order to help a user in identifying inaccurate rules and calculations in the early stages of a business model development; and/or (ii) assist novice users to visualize and author complex rules with relatively little mental effort.

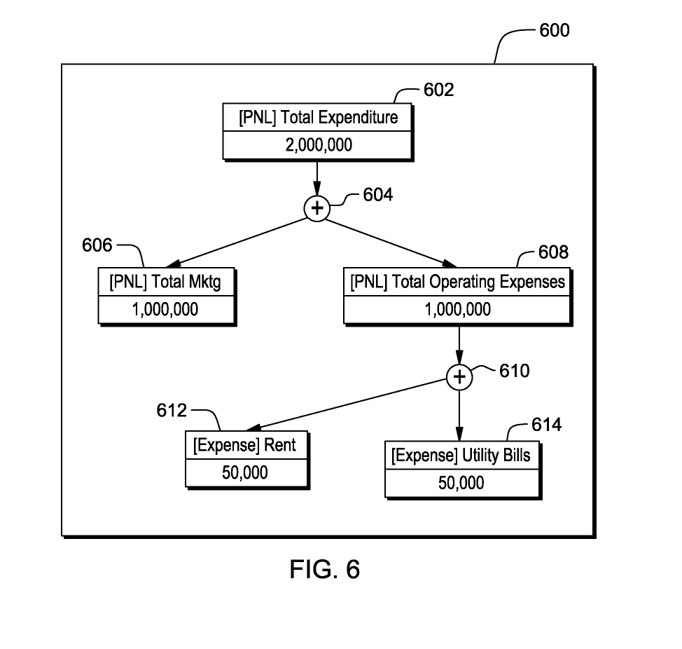

FIG. 6 shows display (or expression tree) 600, which is a display of an expression tree for a business rule used in one or more OLAP cube(s) (OLAP cube(s) not shown). The display is used for debugging the rules responsible for data flow within and/or between OLAP cubes. Expression tree 600 includes: first level node 602; second level operator 604; second level nodes 606, 608; third level operator 610; and third level nodes 612, 614. Expression tree represents a business rule using nodes 602, 606, 608, 612, 614, with each node including a sample value which may be helpful in isolating the problem areas in a rule.

Tree 600 diagrammatically represents the following business rule for use with OLAP cube(s):

[‘Total Expenditure’]=N:[‘Total Marketing Expenses’]+[‘Total Operating Expenses’];

[‘Total Operating Expenses’]=N:DB(‘Expense’, ‘Rent’, !Business Unit, !Region, !Version, !Time)+DB(‘Expense’, ‘Utility Bills’, !Business Unit, !Region, !Version, !Time).

In expression tree 600, a rule is represented in the form of an expression tree so that this complex rule becomes easy to debug and understand. Expression tree 600 also shows sample calculations by dividing the rule into smaller equations giving us the sample results, in the form of numbers, at a granular level. At least some embodiments of the present invention may have one or more of the following features and/or advantages: (i) ease of maintenance; (ii) learning curve reduced; and (iii) visualization makes rules more user friendly.

In currently conventional OLAP cube systems, the associated OLAP tools use a relatively primitive, text-based utility to debug rules. The existing utility has limited visual appeal and makes the debugging experience very difficult and cumbersome for the developer. On the other hand, some embodiments of the present invention combine the advantages of expression trees and business rules to provide a visually simpler and understandable way of debugging the rules in an OLAP environment. Business rules form an important part of daily analysis and budgeting. In a typical customer environment, the rules are very complicated and change very frequently. Some embodiments of the present invention use expression trees to represent business rules, in the OLAP context, to make debugging of business rules easier for the developer.

In making the expression trees according to the present invention, complex rules are: (i) divided into sub parts (and sub-sub-parts, and sub-sub-sub-parts and so on); and (ii) represented in hierarchical form characteristic of expression trees. In some of these embodiments, the expression tree is augmented to give results of intermediate calculations (such as intermediate sample calculations made for purposes of helping people more intuitively understand the complex business rule). Some embodiments of the present invention will better enable the customer to understand and debug its business rules.

Some embodiments of the present invention provide coverage of business rules in the graphical representation (that is, graphical representation of the expression tree's hierarchy).

Some embodiments of the present invention are intended for a developer who is in charge of authoring the rules. The main purpose of these embodiments is to make incremental changes in the rules simpler.

If the business rule is changed by an authorized user based on an expression tree according to the present invention, then this will generally result in changes to data visualization. In some embodiments, the display of the expression will change as the underlying business rule is changed. Also, if an authorized user changes a business rule, pursuant to debugging, then the system may be designed so that the corresponding visualization changes: (i) for all the users of the rule; or (ii) only for himself. In some embodiments: (i) when the user opens the rule editor, he can select the business rule and select the option to visually represent the same rule; (ii) the utility will be interactive in the sense that when the rule is changed visualization of the rule will also change; and/or (iii) utilize the capabilities of expression trees for visualizing business rules and get real time results when an OLAP cube business rule is modified.

In an OLAP system, business rules keep changing according to the changes in business processes of the organization. Keeping track of the changes in formulae and maintaining the accuracy of the rules becomes crucial for financial analysis. Visual representation of business rules in the form of expression trees not only enable a business user to obtain results of business rules on the fly, but they also help the user isolate areas where the business rule is producing erroneous results. Some embodiments of the present invention: (i) combine the power of visualization with business rules in order to help a user in identifying the inaccurate rules and calculations in the early stages of business model development; (ii) assist novice users to visualize and author complex rules with reduced effort; and (iii) the user can identify the cell responsible for a result and make the required changes by entering the data. Item (iii) in the previous sentence basically assists the user in tracing calculations which are responsible for results in a particular cell of the expression tree.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: non-exclusive or; for example, A and/or B means that: (i) A is true and B is false; or (ii) A is false and B is true; or (iii) A and B are both true.

User/subscriber: includes, but is not necessarily limited to, the following: (i) a single individual human; (ii) an artificial intelligence entity with sufficient intelligence to act as a user or subscriber; and/or (iii) a group of related users or subscribers.

What is claimed is:

1. A method for representing a business rule, the method comprising:
determining an expression tree corresponding to the business rule; and
displaying the expression tree;
wherein:
at least the determining and displaying steps are performed by computer software running on computer hardware.

2. The method of claim 1 further comprising:
using the business rule to determine at least a portion of an on-line analytical processing cube.

3. The method of claim 2 further comprising:
subsequent to the displaying step, receiving debugging input for debugging the business rule; and
debugging the business rule according to the debugging input to yield an edited business rule.

4. The method of claim 3 further comprising:
subsequent to the receiving step, determining an edited expression tree based upon the edited business rule; and
displaying the edited expression tree.

5. The method of claim 2 wherein the determining step includes the following two sub-steps:
establishing nodes of the expression tree; and
relating the nodes with relationships and operators between the nodes.
